(19) United States
(12) Patent Application Publication
(10) Pub. No.: US 2019/0118434 A1
(43) Pub. Date: Apr. 25, 2019

(54) PROCESS FOR PRODUCING PARTS HAVING INCREASED IMPACT PERFORMANCE BY USE OF AN INJECTION MOLDING FOAMING PROCESS IN COMBINATION WITH A MOLD CORE-BACK PROCESS

(71) Applicant: SABIC GLOBAL TECHNOLOGIES B.V., Bergen op Zoom (NL)

(72) Inventors: Angel Stoyanov Yanev, Maastricht (NL); Davy Wilhelmus Anna Brands, Maastricht (NL); Josephus Gerardus Maria Van Gisbergen, Bergen op Zoom (NL)

(21) Appl. No.: 16/094,672

(22) PCT Filed: Apr. 11, 2017
(86) PCT No.: PCT/IB2017/052089

§ 371 Date: Oct. 18, 2018

Related U.S. Application Data
(60) Provisional application No. 62/325,583, filed on Apr. 21, 2016.

(51) Int. Cl. B29C 44/58; B29C 44/34; B29C 44/42

(52) U.S. Cl. CPC B29C 44/586; B29K 2509/08; B29C 44/42; B29C 44/3446

(57) ABSTRACT

A process of making a part with improved mechanical performance and improved impact performance compared to a solid part with a same weight by a disclosed foaming process. The process including introducing a glass fiber filled polymeric material to a hopper (128) of an injection molding machine, melting the glass fiber filled polymeric material to form a melt in a plasticizing unit (100), and pressurizing the plasticizing unit (100) of the injection molding machine with a blowing agent. The process further including dissolving the blowing agent into the melt, injecting the melt into a mold cavity (408) of a mold up to 100% of volume, and reconfiguring the mold to increase a size of the mold cavity (408) after a predetermined time after a delivery of the melt. A part made by the process and the device for making the part are also disclosed.

### BACKGROUND OF THE DISCLOSURE

### 1. Field of the Disclosure

This disclosure is directed to a process for producing parts utilizing a modified foaming injection molding processes in combination with a mold core -back process; more particularly, the disclosure is directed to a device and process for producing parts utilizing a modified foaming injection molding process in combination with a mold core-back process; and even more particularly, the disclosure is directed to parts produced by utilizing a modified foaming injection molding process in combination with a mold core-back process.

### 2. Related Art

Production of plastic parts with injection molding foaming technologies is growing constantly, but problems linked to reduction of mechanical properties due to density reduction remain a challenge. For fiber -reinforced materials, this is even more critical due to additional fiber breakage generated during a homogenization phase of a gas and the melt. It has been proven that with certain physical foaming processes, a better fiber retention can be achieved in foaming and even in solid processing. Current penetration level of injection foaming technologies, especially in automotive sector, is limited due to reduced mechanical performance of the plastic parts such as impact performance. An injection foaming process in combination with an increase of the thickness of the application is one of the solutions used on the market, but with this approach impact performance is reduced.

Thus, there is a need in the art for a foamed or light weight part, device for making a foamed or light weight part, and a process for making a foamed or light weight part made from a fiber filled material that has increased impact performance.

### SUMMARY OF THE DISCLOSURE

Additional features, advantages, and aspects of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate aspects of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an injection molding barrel/screw constructed according to the principles of the disclosure.

FIG. 2 shows a hopper and airlock constructed according to the principles of the disclosure.

FIG. 3 shows a controller constructed according to the principles of the disclosure.

FIG. 4 shows a mold constructed according to the principles of the disclosure.

FIG. 5 shows a process of producing a part according to the principles of the disclosure.

FIG. 6 shows a plaque used for investigating test results of a part constructed according to the principles of the disclosure.

FIG. 7 shows test results of a part constructed according to the principles of the disclosure.

FIG. 8 shows test results of a part constructed according to the principles of the disclosure.

FIG. 9 shows test results of a part constructed according to the principles of the disclosure.

FIG. 10 shows test results of a part constructed according to the principles of the disclosure.

### DETAILED DESCRIPTION OF THE DISCLOSURE

The aspects of the disclosure and the various features and advantageous details thereof are explained more fully with reference to the non -limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the disclosure. The examples used herein are intended merely to facilitate an understanding of ways in which the disclosure may be practiced and to further enable those of skill in the art to practice the aspects of the disclosure. Accordingly, the examples and aspects herein should not be construed as limiting the scope of the disclosure, which is defined solely by the appended claims and applicable law. Moreover, it is noted that like reference numerals represent similar parts throughout the several views of the drawings.

In the current state of the art, injection molding foaming results in loss of impact performance. This is most evident in (long) fiber reinforced resins (due to breakage of fibers in addition to normal impact reduction). With the Profoam technology in “solid” or “breathing” mode, reduction of impact performance is less pronounced then for competitive foaming technologies. With these two different approaches, no or limited weight reduction can be achieved. The disclosure is directed to combining Profoam with a “core back” mode, this results in not only weight reduction, but also higher impact performance for parts at equal weight. More specifically, general knowledge and assumptions for injection foaming technologies is that due to density decrease, the impact properties of the foamed application are also reduced. To address this detriment, the disclosure utilizes a modified injection molding foaming technology process in combination with a mold opening or a core-back process to produce a part with an increased impact performance in comparison to the conventional molding foaming technologies. The increase of impact performance was proven on fiber reinforced thermoplastics, such as long glass fiber reinforced polypropylene (LGF-PP) as described herein. Other fiber types using the disclosed process are contemplated to have an increase of impact performance as well. Properties of fiber reinforced thermoplastics are to a large extent determined by the length of fibers. During typical injection molding of such fiber reinforced thermoplastics, breakage of these fibers occurs. With the injection molding foaming technology process, better retention of fiber length has been proven and may play a role on this achievement.

Effective thin-walled structural mechanical designs in long glass fiber reinforced polypropylene (LGF-PP) can bring lightweight solutions in combination with system cost improvement. Reduction of material density potentially offers a further possibility for weight reduction. Applying foaming during injection molding may help achieve this. Chemical foaming and physical foaming via current technologies are known techniques. However, these techniques result in a significant breakdown of the fiber length in long glass fiber reinforced polypropylene (LGF-PP) material, reducing performance. Weight reduction, therefore, comes with a certain loss of performance. This is especially true for long glass filled plastics, for which normally a premium is paid for added performance. The mechanical performance by foaming can be retained or improved as taught by the disclosure and accordingly the potential for usage of long glass fiber (LGF) materials for light-weight solutions increases dramatically.

Disclosed herein are a device and process for making parts. The part can be made from a glass fiber filled polymeric material. Moreover, the process of the disclosure results in limited breakage of the glass fibers in the part. Moreover, certain mechanical properties such as impact resistance can be increased as compared to prior art parts.

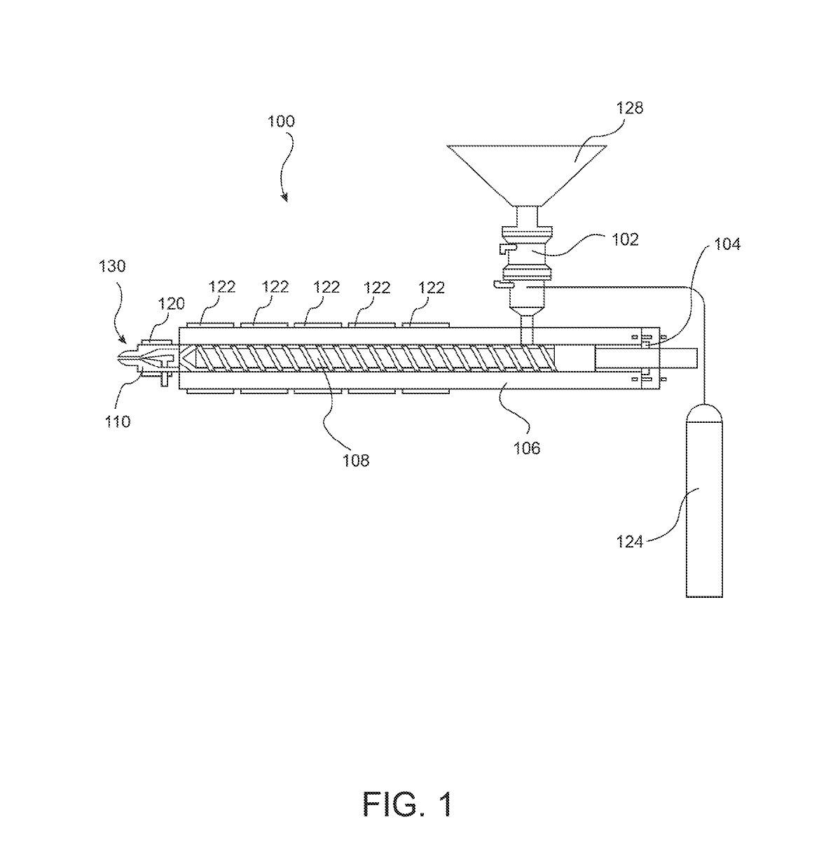

FIG. 1 shows an injection molding barrel/screw constructed according to the principles of the disclosure. As shown in FIG. 1, an injection molding barrel/screw 100 may include a hopper 128. Pellets of fiber reinforced thermoplastics are supplied by the hopper 128 to the injection molding barrel/screw 100 together with a gas (blowing agent) from a gas source 124. During plasticizing of the pellets in the injection molding barrel/screw 100, the gas may dissolve gradually in the melt. It should be noted that the term pellets is utilized throughout the specification only for brevity, other forms of fiber reinforced thermoplastics are contemplated as well. For example, other forms of fiber reinforced thermoplastics may include chopped strands, a mixture of plastic pellets and lose glass fibers, and the like.

The injection molding barrel/screw 100 may include a cylinder 106 maintaining a screw 108. The screw 108 may further include a motor or the like (not shown) for moving the screw 108. The injection molding barrel/screw 100 may further include a seal 104, an airlock 102 and a shutoff valve 110 configured to maintain gas pressure within the cylinder 106. Other constructions associated with the injection molding barrel/screw 100 are contemplated to maintain gas pressure within the cylinder 106 as well.

Additionally, the injection molding barrel/screw 100 may include at least one heater 122. A nozzle 130 and/or an associated shutoff valve 110 may include at least one heater 120. The at least one heater 122 and the at least one heater 120 may be configured to maintain a temperature of the pellets and/or increase the temperature of the pellets to melt the same.

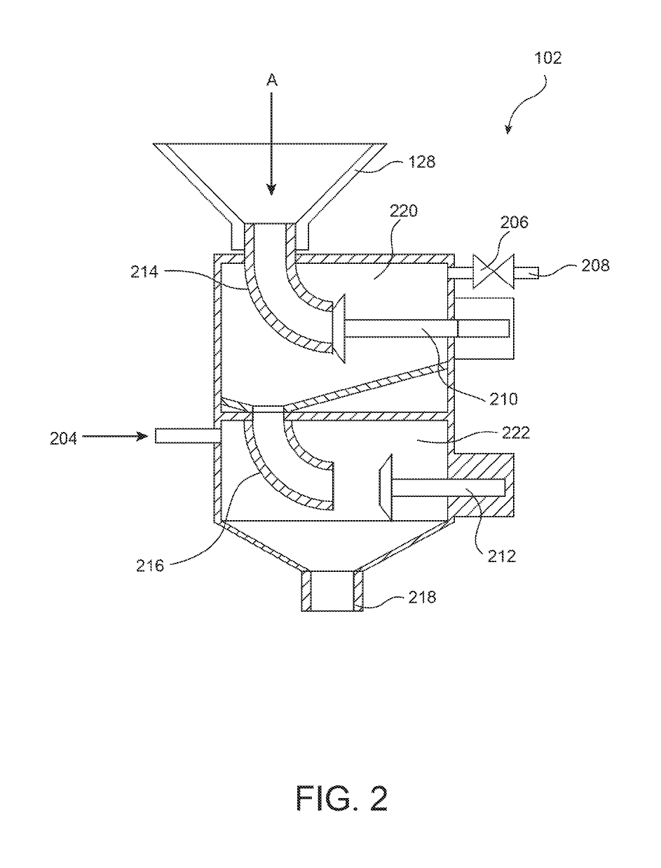

FIG. 2 shows a hopper and airlock constructed according to the principles of the disclosure. In particular, the airlock 102 may include the hopper 128. The hopper 128 may additionally be configured separately from the airlock 102. Pellets from the hopper 128 may enter a conduit 214 within the airlock 102. Control of the movement of the pellets within the airlock 102 may be controlled by a first valve 210 (shown in the closed configuration). Opening of the first valve 210 towards the right will allow the pellets from the hopper 128 to enter an upper portion 220 of the airlock 102. Thereafter, the pellets may travel to a conduit 216.

A second valve 212 (shown in the open position) controls movement of the pellets from the conduit 216 into a lower portion 222 of the airlock 102. In the lower portion 222, a blowing agent from the gas source 124 may be applied to an input 204 within the lower portion 222. The blowing agent may only be applied once the second valve 212 has been closed. The input 204 may include a valve (not shown) to control a flow of the blowing agent. Pellets in the lower portion 222 will travel through the connection 218 to the injection molding barrel/screw 100. It should be noted that the blowing agent may be injected at other locations as well.

The airlock 102 may further include a valve 206 that provides an outlet 208 for the blowing agent. The valve 206 may be opened to release the blowing agent through the outlet 208 after the second valve 212 is opened when the blowing agent has pressurized the lower portion 222. Actuation and operation of the first valve 210, the second valve 212, the valve 206, the blowing agent valve, the at least one heater 120, the at least one heater 122, the shutoff valve 110, the screw motor, and the like may be controlled by a controller 350 as described herein.

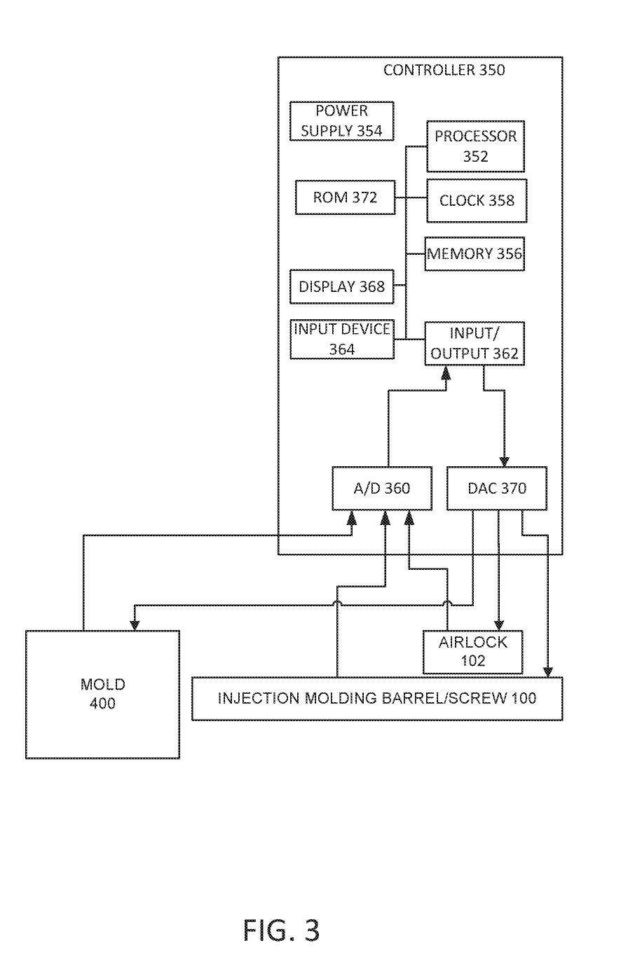

FIG. 3 shows a controller constructed according to the principles of the disclosure. The controller 350 may receive sensor outputs from a temperature sensor sensing temperature from any part of the injection molding barrel/screw 100 and associated system, a pressure sensor sensing pressure from a part of the injection molding barrel/screw 100 and associated system, a position sensor sensing position of a part of the injection molding barrel/screw 100 and associated system, and the like.

The controller 350 may include a processor 352. This processor 352 may be operably connected to a power supply 354, a memory 356, a clock 358, an analog to digital converter (A/D) 360, an input/output (I/O) port 362, and the like. The I/O port 362 may be configured to receive signals from any suitably attached electronic device and forward these signals from the A/D 360 and/or to processor 352. These signals includes signals from the temperature sensor sensing temperature from any part of the injection molding barrel/screw 100 and associated system, the pressure sensor sensing pressure from a part of the injection molding barrel/screw 100 and associated system, the position sensor sensing position of a part of the injection molding barrel/screw 100 and associated system, and the like. If the signals are in analog format, the signals may proceed via the A/D 360. In this regard, the A/D 360 may be configured to receive analog format signals and convert these signals into corresponding digital format signals.

The controller 350 may include a digital to analog converter (DAC) 370 that may be configured to receive digital format signals from the processor, convert these signals to analog format, and forward the analog signals from the I/O port 362. In this manner, electronic devices configured to utilize analog signals may receive communications or be driven by the processor 352. The processor 352 may be configured to receive and transmit signals to and from the DAC 370, A/D 360 and/or the I/O port 362. The processor 352 may be further configured to receive time signals from the clock 358. In addition, the processor 352 may be configured to store and retrieve electronic data to and from the memory 356. The controller 350 may further include a display 368, an input device 364, and a read-only memory (ROM) 372. Finally, the processor 352 may include a program stored in the memory 356 executed by the processor 352 to execute the process 300 described below.

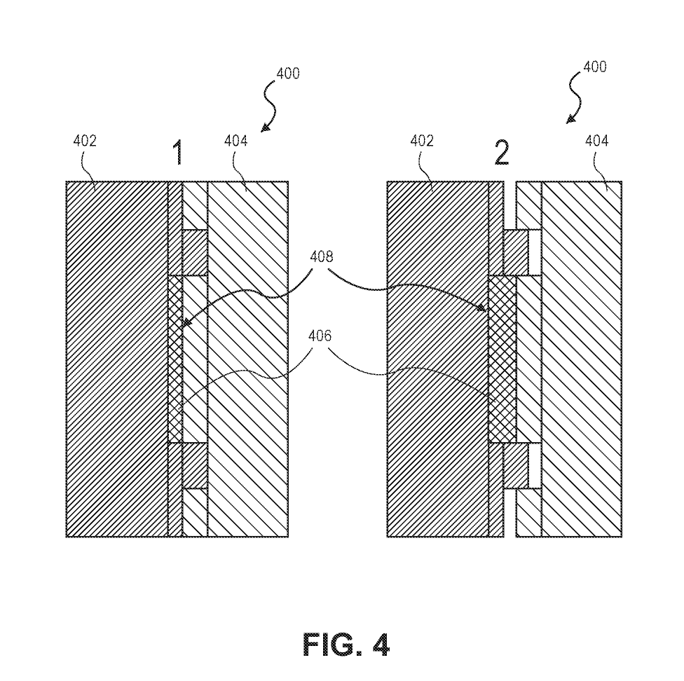

FIG. 4 shows a mold constructed according to the principles of the disclosure. In particular, FIG. 4 shows a core-back tool 400 in a first configuration 1 and a second configuration 2. Core-back, also known as breathing or decompression molding, refers to a controlled opening of the core-back tool 400 from its initial thickness to the desired end thickness. The core-back tool 400 may include a first mold component 402 and a second mold component 404. Additional mold components associated with the core-back tool 400 may be utilized as well.

During the molding process that is described in greater detail below, the first mold component 402 and the second mold component 404 of the core-back tool 400 may be in the first configuration 1. The part to be molded 406 may be subjected to a mold cavity 408 that is sized based on the first configuration 1.

During the process, the first mold component 402 and the second mold component 404 of the core-back tool 400 may be reconfigured to the second configuration 2. Thereafter, the part to be molded 406 may be subjected to a mold cavity 408 that is sized based on the second configuration 2. In one aspect, the mold cavity 408 may be larger in one dimension in the second configuration 2 in comparison to the first configuration 1. In one aspect, the mold cavity 408 may be larger in two dimensions in the second configuration 2 in comparison to the first configuration 1. In one aspect, the mold cavity 408 may be larger in three dimensions in the second configuration 2 in comparison to the first configuration 1.

The controller 350 and I/O port 362 may be configured to control operation of the core-back tool 400 and receive signals from the core-back tool 400. These signal includes signals from a temperature sensor sensing temperature from any part of the core-back tool 400 and associated system, a pressure sensor sensing pressure from a part of the core-back tool 400 and associated system, a position sensor sensing position of a part of the core-back tool 400 and associated system, and the like. The controller 350 may control operation of the core-back tool 400 including the configurations.

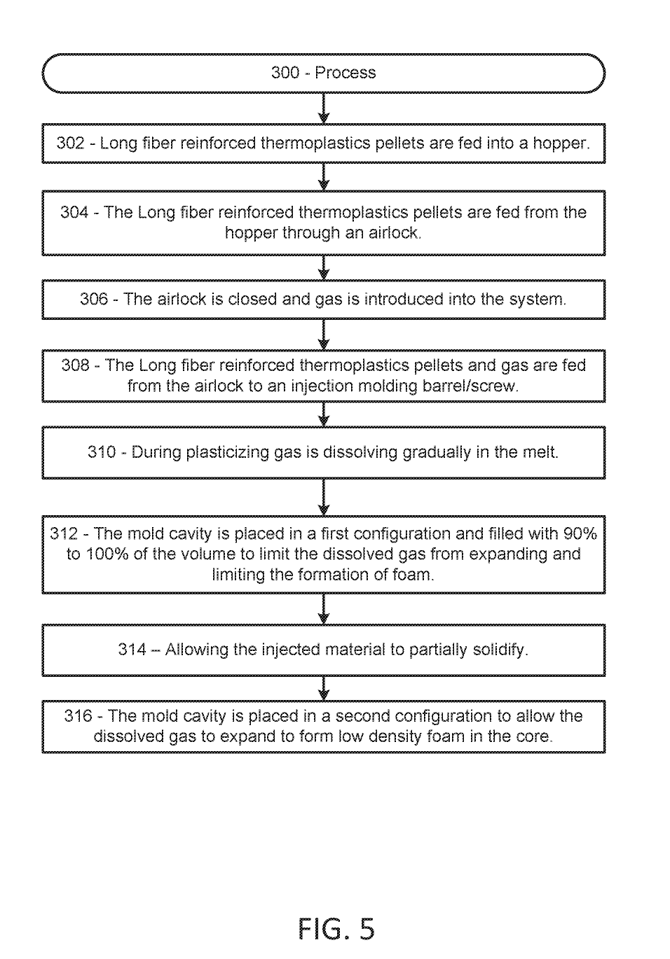

FIG. 5 shows a process of constructing parts according to the principles of the disclosure. In particular, FIG. 5 shows a process 300 for producing parts having at least greater impact performance. In box 302, fiber reinforced thermoplastics pellets are fed into a hopper 128. Thereafter, in box 304, the fiber reinforced thermoplastics pellets are fed from the hopper 128 through an airlock 102. As shown in box 306, the airlock may be closed. This includes closing of one or more of the first valve 210 and the second valve 212.

As described in box 308, the fiber reinforced thermoplastics pellets are fed from the airlock 102 to the injection molding barrel/screw 100 together with the gas. As described in box 310, during plasticizing in the injection molding barrel/screw 100, the gas may dissolve gradually in the melt. Additionally, the disclosed process may further benefit from having no and/or limited abrasive mixing elements in the injection molding barrel/screw 100 to further reduce fiber breakage.

In the process 300, the injection molding barrel/screw 100 (or other portion of a plasticizing unit of the injection molding machine) may be pressurized with the gaseous blowing agent. To prevent the loss of the blowing agent at the end of the screw, the seal 104 may be arranged between the screw 108 and the cylinder 106. The injection molding barrel/screw 100 and/or plasticizing unit itself may be sealed with the airlock 102 that is mounted between the injection molding barrel/screw 100 and the hopper 128. The injection molding barrel/screw 100 and/or plasticizing unit may be equipped with a shutoff valve 110 and a position control for the screw 108 to keep the blowing-agent-loaded melt under pressure until it is injected into the core-back tool 400. The injection molding barrel/screw 100 may be implemented as a 3-zone screw without any abrasive elements for dissolving the gas into the melt. In one aspect, the pressurizing is performed in more than 50% of a volume of the plasticizing unit. In one aspect, the pressurizing is performed in more than 50% to 100% of a volume of the plasticizing unit. In one aspect, the pressurizing is performed in more than 50% to 60% of a volume of the plasticizing unit. In one aspect, the pressurizing is performed in more than 60% to 70% of a volume of the plasticizing unit. In one aspect, the pressurizing is performed in more than 70% to 80% of a volume of the plasticizing unit. In one aspect, the pressurizing is performed in more than 80% to 90% of a volume of the plasticizing unit. In one aspect, the pressurizing is performed in more than 90% to 100% of a volume of the plasticizing unit.

As described in box 312, the mold cavity 408 of the core-back tool 400 may be in the first configuration 1 and may be filled up to 90-100% of volume. In one aspect, the mold cavity 408 of the core-back tool 400 may be in the first configuration 1 and may be filled with 95-100% of volume. In one aspect, the mold cavity 408 of the core-back tool 400 may be in the first configuration 1 and may be filled with 90-95% of volume. In one aspect, the mold cavity 408 of the core-back tool 400 may be in the first configuration 1 and may be filled up to 100% of volume. In one aspect, a packing pressure is applied. This may limit the dissolved gas from expanding the part 406, thus limiting the formation of foam. In one aspect, no packing pressure is applied. Because of this process, the part 406 may contain solid fiber reinforced thermoplastics material but with longer fibers than normally would be achieved using the same settings and approach without pressurization and gas dissolving.

As described in box 314, the core-back tool 400 may be maintained in the first configuration 1 for a predetermined time and/or predetermined pressure. In one aspect, during this predetermined time, the injected material forming the part 406 may solidify at the surface or skin of the part 406 that is adjacent a surface of the mold cavity 408. In one aspect, during this predetermined time, the injected material forming the part 406 may partially solidify.

Finally, as described in box 316, the mold cavity 408 of the core -back tool 400 may be placed in the second configuration 2. The second configuration 2 having a greater size, thickness, and so on. While in the second configuration 2, the dissolved gas within the injected material may be allowed to at least partially expand to form foam within the part 406. In one aspect, the foam may be a low density foam. In one aspect, the foam may form in a core of the part 406. In one aspect, the foam may form in a center of the part 406. In one aspect, the foam may form in thicker areas of the part 406.

The result is a foamed part, which, compared to a solid part with initial thickness, has increased thickness and the same weight, but improved impact performance in comparison to the conventional (solid) injection molding and incumbent foaming technologies. Impact performance is defined here as impact penetration energy and maximum penetration force measured in a falling dart experiment as described in detail below. The part produced by the disclosed process has better impact performance results compared to solid parts by at least combining a physical foaming process and core-back tool opening technology process.

During trials it was discovered that by applying certain processing settings with dissolving gas into the melt, fiber length retention is better than with standard compact injection molding. Optimal conditions are achieved when increase of gas pressure is accompanied by the increase of the backpressure and a gap of 5 bar is left between two in favor of the backpressure. In another aspect, optimal conditions are achieved when increase of gas pressure is accompanied by the increase of the backpressure and a gap of at least 5 bar is left between two in favor of the backpressure. In another aspect, optimal conditions are achieved when increase of gas pressure is accompanied by the increase of the backpressure and a gap of 3 to 7 bar is left between two in favor of the backpressure. In another aspect, optimal conditions are achieved when increase of gas pressure is accompanied by the increase of the backpressure and a gap of 4 to 6 bar is left between two in favor of the backpressure. More specifically, the difference between the gas pressure in the system (pressurized barrel) and the backpressure applied during a plasticizing stage should be minimal (4 to 6 bars) to prevent additional shear. Pressure of the gas may be up to 35 bar for certain materials in certain applications. Further increase of the gas pressure may have a negative impact on the fiber length for these certain materials and applications. Nevertheless, different pressures with different materials for different applications are contemplated as well. By using this process of dissolving gas into the melt and the processing parameters specified, parts with longer fibers compared to standard injection molded parts are produced.

Properties of fiber reinforced thermoplastics are to a large extent determined by the length of fibers. During injection molding of such fiber reinforced thermoplastics, breakage of these fibers occurs. It was discovered that by dissolving gas into the melt in the injection molding barrel/screw 100 fiber breakage could be reduced significantly. Thus, parts can be molded, containing longer fibers, compared to conventionally injected parts. By having longer fibers in the molded parts, mechanical performance of the application can be improved and further weight reduction can be achieved. Additionally, the disclosed modified injection molding foaming technology process in combination with mold opening or core-back process produces a part that results in an increase of impact performance.

Semi-structural parts including injection molded long fiber reinforced thermoplastics (LFRTP) typically display better stiffness, strength and impact behavior in comparison to short fiber reinforced materials. As such, these types of materials usually compete more towards high end applications than short fiber filled materials and can be sold at good pricing. For example the mechanical behavior of SABIC™ STAMAX™ PP-LGF (Polypropylene—Long Glass Fiber) competes to a typical Polyamide SGF (Short Glass Fibers) material. Key for material and application performance is in-part fiber length. The main challenge in converting LFRTP materials is to keep the long fibers, initially present in the pellets, as long as possible in the part during the plasticizing process. This requires a narrow processing window. The current disclosure widens the window of operation considerably and leads to longer fibers compared to optimal standard injection molding settings, thus improving part performance and LFRTP competitiveness.

Introducing gas into the injection molding barrel/screw 100 reduces the fiber breakage in the melt, such as in the injection molding barrel/screw 100. In particular, use of a foaming injection molded process may reduce friction in the process and produce injection molded parts with longer fibers. By use of the disclosed process, fiber retention in the injection molding barrel/screw 100 is improved, thus parts can be molded containing longer fibers, compared to conventionally injected parts.

Accordingly, the disclosed modified injection molding foaming technology in combination with a mold opening or a core-back process produces a part that results in an increase of impact performance. The increase of impact performance was proven on fiber reinforced thermoplastics, such as long glass fiber reinforced polypropylene (LGF-PP) as described below.

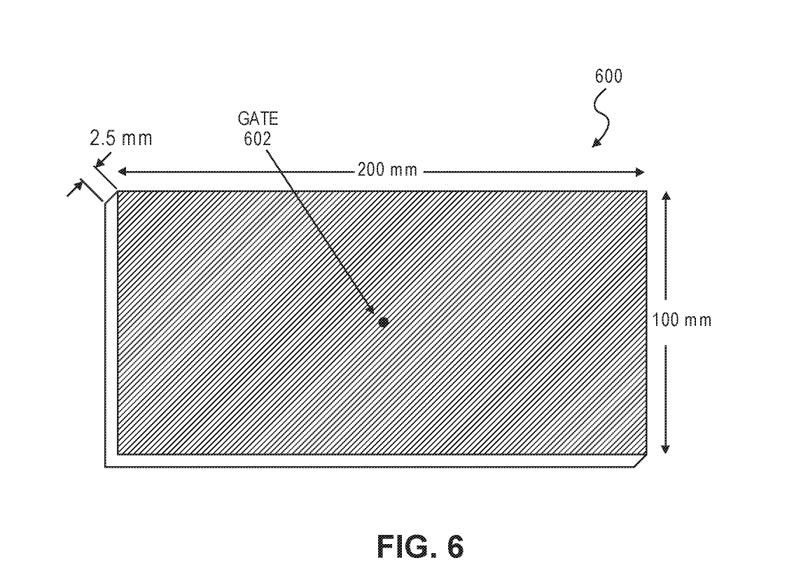

FIG. 6 shows a plaque used for investigating test results of a part constructed according to the principles of the disclosure. In particular, FIG. 5 shows a plaque 600. The plaque 600 is approximately 200 mm (millimeter)×100 mm and has a thickness of 2.5 mm. The plaque 600 includes a central gate 602 of 2.5 mm. The plaque 600 was produced with an Arburg Allrounder 520A 1500-400 injection molding machine having a 35 mm barrel.

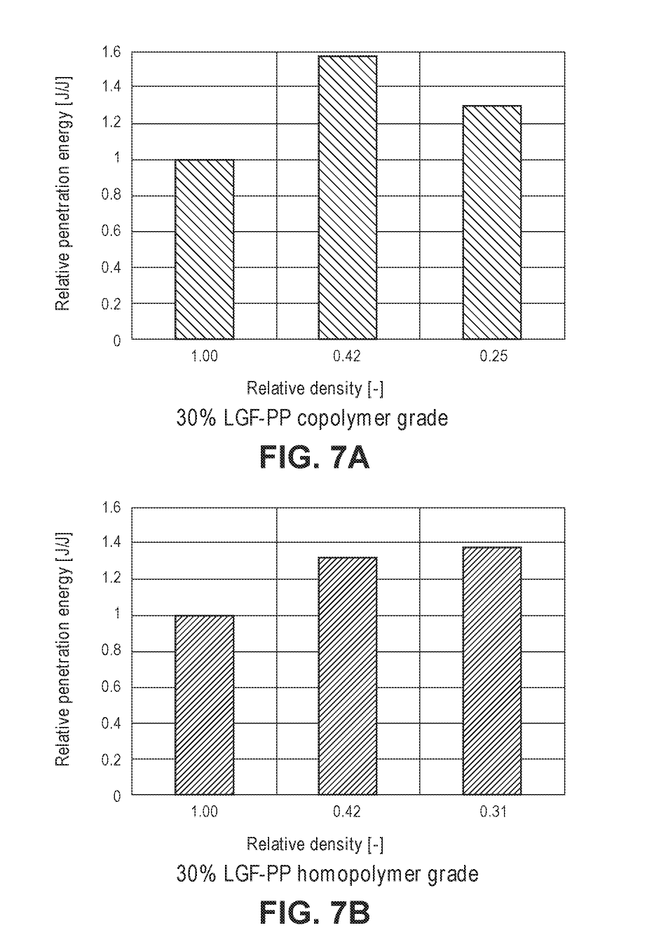

FIG. 7 shows test results of a part constructed according to the principles of the disclosure. Falling dart, or so-called bi-axial impact, experiments were performed for two grades of SABIC®STAMAX™ long glass fiber reinforced polypropylene (LGF-PP) with 30% glass content with an initial length of the glass in the pellets of 12.5 mm. One of the grades is with homopolymer (STAMAX™ 30YM240) and the other is with copolymer (STAMAX™ 30YK270). The plaques 600 were produced by using the same processing conditions and same base thickness (2.5 mm) with reference to FIG. 6. The foaming in the samples was obtained by use of a gas dissolving technology marketed as Profoam™ in combination with core-back process technology as set forth in this disclosure. As noted above, the core-back, also known as breathing or decompression molding, refers to controlled opening of the core-back tool 400 from its initial thickness to the desired end thickness. In the experiments conducted for this investigation, different thickness increases were applied to the different long glass fiber reinforced polypropylene (LGF-PP) grades.

As shown in FIG. 7A, a 30% long glass fiber reinforced polypropylene (LGF-PP) copolymer grade of material was utilized; and as shown FIG. 7B a 30% long glass fiber reinforced polypropylene (LGF-PP) homopolymer grade was utilized. The penetration energy in joules [J] from the falling dart experiments have been normalized to a solid plaque value joules/joules [J/J]. In this regard, normalization is calculated with respect to penetration energy of a solid plaque with the same weight. For example, for a relative density 1 (solid part) the normalized value is 1; for a part with increased thickness (from 2.5 mm to 6 mm) and a relative density of 0.42, the impact penetration is increased 1.5 times with respect to the solid part; and for a further increase of thickness to 10 mm, the value is still 1.3 times above the solid plaque. Density decrease obtained via material foaming and core-back thickness increase is at a constant weight. The thickness used for the experiment (relative density obtained) is as follows: Solid: 2.5 mm (1.00), Foamed: 6 mm (0.42), 7.5 mm (0.31) and 10 mm (0.25). As is shown in FIG. 7A and FIG. 7B, the Foamed: 6 mm (0.42), 7.5 mm (0.31) and 10 mm (0.25) plaques 600 had a greater relative penetration energy compared to the solid plaque 600 (Solid: 2.5 mm (1)).

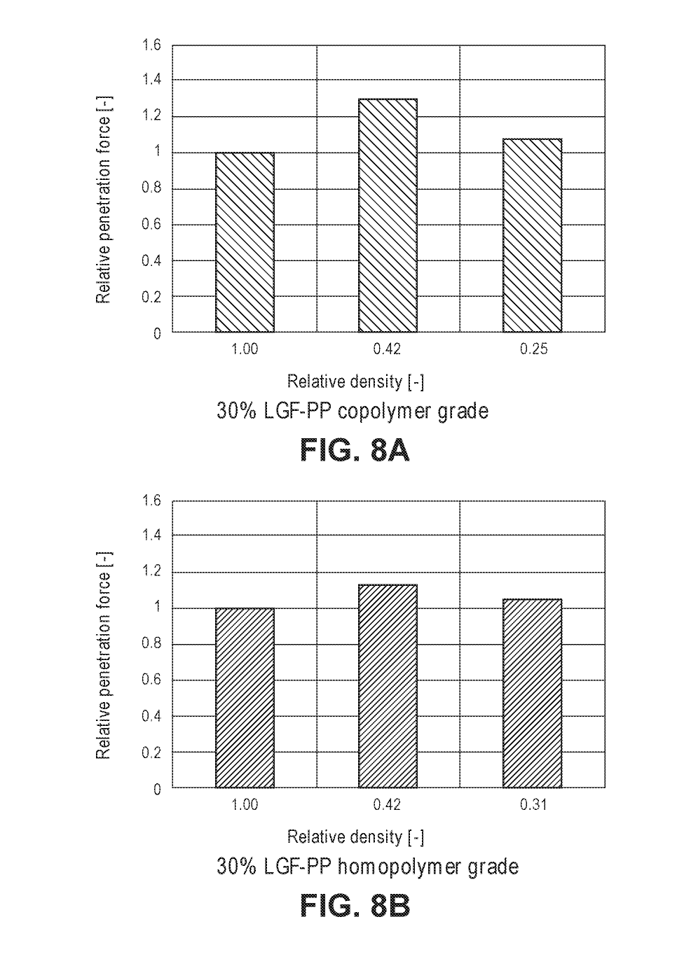

FIG. 8 shows test results of a part constructed according to the principles of the disclosure. As shown in FIG. 8A, a 30% long glass fiber reinforced polypropylene (LGF-PP) copolymer grade of material was utilized; and as shown FIG. 8B a 30% long glass fiber reinforced polypropylene (LGF-PP) homopolymer grade was utilized. As shown in FIG. 8, the maximum penetration force from a falling dart experiment, was normalized to a solid plaque value. Density decrease obtained via material foaming and core-back thickness increase was at constant weight. Thickness used (relative density obtained) was: Solid: 2.5 mm (1.00), Foamed: 6 mm (0.42), 7.5 mm (0.31) and 10 mm (0.25). As is shown in FIG. 8A and FIG. 8B, the Foamed: 6 mm (0.42), 7.5 mm (0.31) and 10 mm (0.25) plaques 600 had a greater relative penetration force compared to the solid plaque 600 (Solid: 2.5 mm (1.00)).

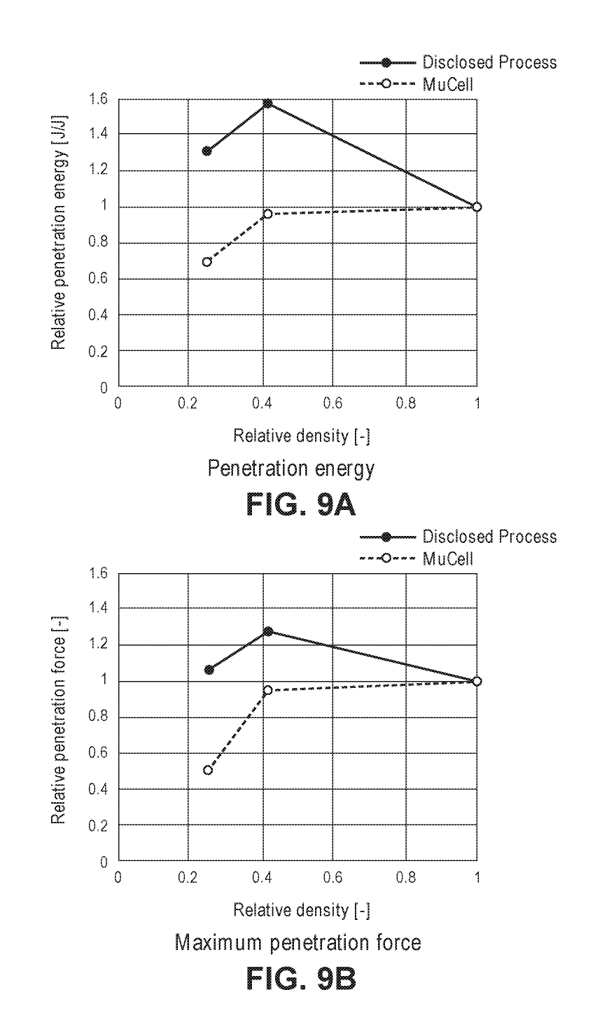

FIG. 9 shows test results of a part constructed according to the principles of the disclosure. FIG. 9 is a comparison of the process according to the disclosure vs. a MuCell® process for 30% long glass fiber reinforced polypropylene (LGF-PP) copolymer grade. FIG. 9A shows a penetration energy in joules [J] from a falling dart experiment, normalized to a solid plaque value joules/joules [J/J]. FIG. 9B shows a maximum penetration force from a falling dart experiment, normalized to a solid plaque value. Density decrease obtained via material foaming and core-back thickness increase at constant weight. Thickness used (relative density obtained): Solid: 2.5 mm (1), Foamed: 6 mm (0.42) and 10 mm (0.25). More specifically, FIG. 9 compares the results obtained with ProFoam™ plus core-back technology process as set forth by the disclosure with an existing MuCell® plus core-back technique. The advantage in impact performance of samples obtained with based on the teachings of the disclosure versus those obtained with MuCell® is significant. In fact, impact performance of samples produced with MuCell® is decreased with reduction of the density, while in case of the process as set forth by the disclosure performance is increased.

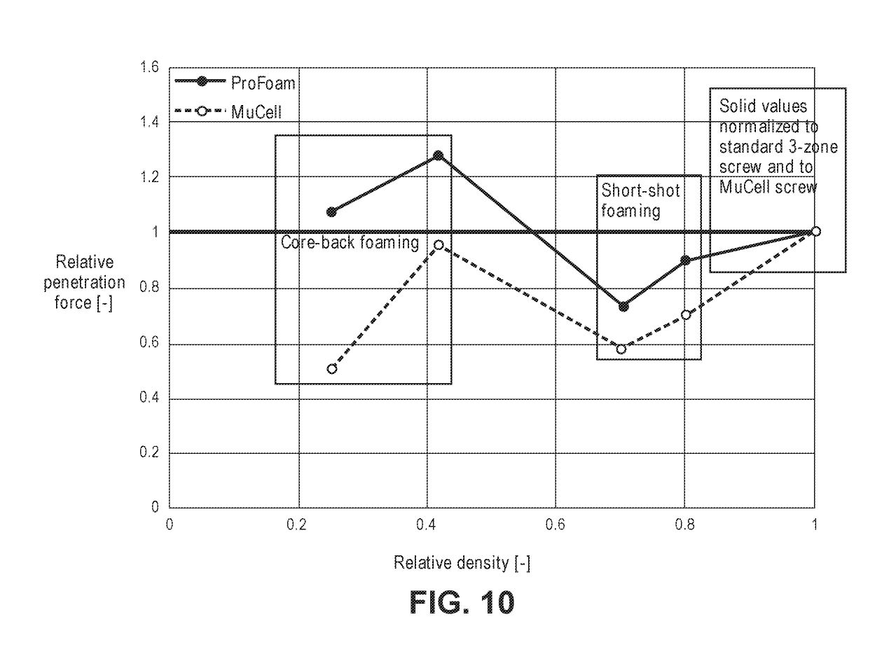

FIG. 10 shows test results of a part constructed according to the principles of the disclosure. In particular, FIG. 10 shows a comparison of the different foaming techniques with respect to relative penetration force, normalized to a solid plaque value. Different screws had to be used for different foaming techniques, a standard 3-zone screw for the process according to the disclosure and a MuCell® screw for MuCell® foaming, leading to different performance of the reference solid plaques. For this reason, the values presented are normalized to values obtained using solid plaques obtained with a respective screw used for different technology. Short-shot foaming is achieved by injecting less volume in the cavity and allowing gas, loaded in the melt to expand as to fill the rest of the volume. The advantage in impact performance of samples obtained with the process according to the disclosure versus those obtained with the MuCell® process is apparent for all technologies, but only the combination of the ProFoam™ in combination with the core-back molding process, as disclosed, gives better impact performance compared to solid sample. This finding is significant taking into account the large density decrease in the samples.

Based on the findings described above and shown in FIGS. 7-10, the use of the disclosed process is beneficial for at least impact performance. More specifically, the findings described above and shown in FIGS. 7-10, show that a part produced with the disclosed process and/or disclosed device results in a part having a relative density less than one and the part has an impact performance greater than a similarly dimensioned part made without pressurizing a plasticizing unit. Moreover, the findings described above and shown in FIGS. 7-10, show that a part produced with the disclosed process and/or disclosed device having a relative density less than one and results in a part having an impact performance greater than a similarly dimensioned solid part. Additionally, the findings described above and shown in FIGS. 7-10, show that a part produced with the disclosed process and/or disclosed device results in a part having a relative density less than 0.5 and the part has an impact performance greater than a similarly dimensioned part made without pressurizing a plasticizing unit. Moreover, the findings described above and shown in FIGS. 7-10, show that a part produced with the disclosed process and/or disclosed device having a relative density less than 0.5 results in a part having an impact performance greater than a similarly dimensioned solid part. This increases the opportunities for designing and processing lightweight applications with long glass fiber materials. In one aspect, the impact performance comprises a relative penetration force. In one aspect, the impact performance comprises a relative penetration energy. In one aspect, the impact performance comprises a relative penetration force and a relative penetration energy. This increases the opportunities for designing and processing lightweight applications with long glass fiber materials. Accordingly, a part formed according to the disclosure has an impact performance greater than a part with a same weight made without pressurizing the plasticizing unit in more than 50% of its volume, and the part has an impact performance greater than a solid part with a same weight.

By using this technology, parts containing longer fibers can be produced. This is beneficial for the LFRTP materials, since fiber length is a determining factor for mechanical performance of the LFRTP applications. Another advantage of having better retention of fiber length with this process is to have a far wider processing window. The processing window for LFRTP materials is very narrow as the main issues are fiber retention and fiber dispersion, which contradict each other in processing. If enough shear is introduced into the processing, the dispersion is good, but fiber length is reduced and in contrary, if lower shear is applied the fiber retention is good, dispersion can be an issue. With this process, a larger processing window can be achieved resulting in good fiber dispersion in combination with relatively good fiber retention. Additionally, the process of the disclosure can be applied to other materials including Short Glass Fibers (SGF) materials and Direct Long Fiber Thermoplastic (DLFT) materials with similar benefits.

It is to be understood that any thermoplastic material can be processed using the methods disclosed herein. For example, the polymer can include polyphenylene ether-based resin, polyacetal-based resin, polyamide -based resin, polystyrene-based resin, polymethyl methacrylate based resin, polyacrylonitrile-based resin, polyester-based resin, polycarbonate, polyphenylene sulfide, polyetherimide, polyethersulfone, polysulfone, polyether (ether) ketone, polyolefin-based resin, polyethylene terephthalate based resin (PET), poly p phenylene based resin, polyvinyl chloride (PVC) based resin, polytetrafluoroethylene (PTFE) based resin and combinations including at least one of the foregoing.

Possible polymeric resins that may be employed include, but are not limited to, oligomers, polymers, ionomers, dendrimers, copolymers such as graft copolymers, block copolymers (e.g., star block copolymers, random copolymers, etc.) and combinations including at least one of the foregoing. Examples of such polymeric resins include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (e.g., polyetherimides), acrylonitrile-styrene-butadiene (ABS), polyalkylmethacrylates (e.g., polymethylmethacrylates), polyesters (e.g., copolyesters, polythioesters), polyolefins (e.g., polypropylenes and polyethylenes, high density polyethylenes, low density polyethylenes, linear low density polyethylenes), polyamides (e.g., polyamideimides), polyarylates, polysulfones (e.g., polyarylsulfones, polysulfonamides), polyphenylene sulfides, polytetrafluoroethylenes, polyethers (e.g., polyether ketones, polyether etherketones, polyethersulfones), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazzanes, polysiloxanes, and combinations including at least one of the foregoing.

More particularly, the polymeric can include, but is not limited to, polycarbonate resins (e.g., LEXAN™ resins, commercially available from SABIC such as LEXAN™ XHT, LEXAN™ HFD, etc.), polyphenylene ether-polystyrene blends (e.g., NORYL™ resins, commercially available from SABIC), polyetherimide resins (e.g., ULTEM™ resins, commercially available from SABIC), polybutylene terephthalate-polycarbonate blends (e.g., XENOY™ resins, commercially available from SABIC), copolyestercarbonate resins (e.g. LEXAN™ SLX or LEXAN™ FST resins, commercially available from SABIC), acrylonitrile butadiene styrene resins (e.g., CYCOLOY™ resins, commercially available from SABIC), polyetherimide/siloxane resins (e.g., SILTEM™, commercially available from SABIC), polypropylene resins, for example, long glass fiber filled polypropylene resins (e.g., STAMAX™ resins, commercially available from SABIC), and combinations including at least one of the foregoing resins. Even more particularly, the polymeric resins can include, but are not limited to, homopolymers and copolymers of a polycarbonate, a polyester, a polyacrylate, a polyamide, a polyetherimide, a polyphenylene ether, or a combination including at least one of the foregoing resins. The polycarbonate can include copolymers of polycarbonate (e.g., polycarbonate-polysiloxane, such as polycarbonate -polysiloxane block copolymer), linear polycarbonate, branched polycarbonate, end-capped polycarbonate (e.g., nitrile end-capped polycarbonate) blends of PC, such as PC/ABS blend, and combinations including at least one of the foregoing, for example a combination of branched and linear polycarbonate.

In one aspect, the polymeric material includes glass fibers. The glass fibers, as described herein, include glass fibers with an initial length of greater than or equal to 3 mm. However, in other aspects glass fibers with other initial lengths benefit from the process of the disclosure. The polymeric can include various additives ordinarily incorporated into polymer compositions of this type, with the proviso that the additive(s) are selected so as to not significantly adversely affect the desired properties of the part, in particular, mechanical properties, such as impact resistance. Such additives can be mixed at a suitable time during the mixing of the polymeric material for the part. Exemplary additives include impact modifiers, fillers, reinforcing agents, antioxidants, heat stabilizers, light stabilizers, ultraviolet (UV) light stabilizers, plasticizers, lubricants, mold release agents, antistatic agents, colorants (such as carbon black and organic dyes), surface effect additives, anti-ozonants, thermal stabilizers, anti-corrosion additives, flow promoters, pigments, dyes radiation stabilizers (e.g., infrared absorbing), flame retardants, and anti-drip agents. A combination of additives can be used, for example a combination of a heat stabilizer, mold release agent, and ultraviolet light stabilizer. In general, the additives are used in the amounts generally known to be effective. The total amount of additives (other than any impact modifier, filler, or reinforcing agent) is generally 0.001 wt % to 5 wt %, based on the total weight of the polymeric material composition.

The addition of the blowing agent can be achieved by adding a gas such as nitrogen, oxygen, or carbon dioxide within a defined pressure and temperature range to the polymer melt. Within this range the gas can be dissolved within the polymer melt during plasticizing. Further, the gas may become a supercritical fluid during this process (but does not have to). Various techniques can be used to add the gas to the melt, including adding the gas to the melt in the machine barrel (technique 1) and adding the gas to the melt in an adapted hot runner system.

Technique 1 involves metering a gas such as nitrogen into the polymer melt stream as it moves down the barrel. The gas is thoroughly mixed into the polymer creating a single phase solution of polymer and gas.

Articles produced according to the disclosure include, for example, computer and business machine housings, home appliances, trays, plates, handles, helmets, automotive parts such as instrument panels, cup holders, glove boxes, interior coverings and the like. In various further aspects, formed articles include, but are not limited to, food service items, medical devices, animal cages, electrical connectors, enclosures for electrical equipment, electric motor parts, power distribution equipment, communication equipment, computers and the like, including devices that have molded in snap fit connectors. In a further aspect, articles of the present disclosure include exterior body panels and parts for outdoor vehicles and devices including automobiles, protected graphics such as signs, outdoor enclosures such as telecommunication and electrical connection boxes, and construction applications such as roof sections, wall panels and glazing. Multilayer articles made of the disclosed polycarbonates particularly include articles which will be exposed to UV-light, whether natural or artificial, during their lifetimes, and most particularly outdoor articles; i.e., those intended for outdoor use. Suitable articles are exemplified by enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; wall panels, and doors; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; computer housings; desk-top computer housings; portable computer housings; lap-top computer housings; palm-held computer housings; monitor housings; printer housings; keyboards; facsimile machine housings; copier housings; telephone housings; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated articles; and like applications.

In one aspect, the parts can include articles including the disclosed glass fiber filled polymeric materials. In a further aspect, the article including the disclosed glass fiber filled polymeric materials can be used in automotive applications. In a yet further aspect, the article includes the disclosed glass fiber filled polymeric materials can be selected from instrument panels, overhead consoles, interior trim, center consoles, panels, quarter panels, rocker panels, trim, fenders, doors, deck lids, trunk lids, hoods, bonnets, roofs, bumpers, fascia, grilles, minor housings, pillar appliqués, cladding, body side moldings, wheel covers, hubcaps, door handles, spoilers, window frames, headlamp bezels, headlamps, tail lamps, tail lamp housings, tail lamp bezels, license plate enclosures, roof racks, and running boards. In an even further aspect, the article including the disclosed glass fiber filled polymeric materials can be selected from mobile device exteriors, mobile device covers, enclosures for electrical and electronic assemblies, protective headgear, buffer edging for furniture and joinery panels, luggage and protective carrying cases, small kitchen appliances, and toys.

In one aspect, the parts can include electrical or electronic devices including the disclosed glass fiber filled polymeric materials. In a further aspect, the electrical or electronic device can be a cellphone, a MP3 player, a computer, a laptop, a camera, a video recorder, an electronic tablet, a pager, a hand receiver, a video game, a calculator, a wireless car entry device, an automotive part, a filter housing, a luggage cart, an office chair, a kitchen appliance, an electrical housing, an electrical connector, a lighting fixture, a light emitting diode, an electrical part, or a telecommunications part.

The methods disclosed herein can provide favorable results with respect to the use of glass fiber filled materials since the loss of mechanical properties due to fiber length is upheld or increased as compared to the original fiber length in other moldings. Furthermore, initial cost for adapting the injection unit is low as only the pressurizing unit is an additional component.

### EXAMPLES

Example 1. A process of making a part comprising: introducing a glass fiber filled polymeric material to a hopper of an injection molding machine; melting the glass fiber filled polymeric material to form a melt in a plasticizing unit; pressurizing the plasticizing unit of the injection molding machine with a blowing agent, wherein the pressurizing is performed in more than 50% of the volume of the plasticizing unit; dissolving the blowing agent into the melt; injecting the melt into a mold cavity of a mold up to 100% of volume; and reconfiguring the mold to increase a size of the mold cavity after a predetermined time after a delivery of the melt, to produce a part having a relative density less than one, the part having an impact performance greater than a part with a same weight made without pressurizing the plasticizing unit in more than 50% of its volume, and the part having an impact performance greater than a solid part with a same weight.

Example 2. The process of Example 1, wherein the impact performance comprises a relative penetration force.

Example 3. The process of any one of Examples 1-2, wherein the impact performance comprises a relative penetration energy.

Example 4. The process of any one of Examples 1-3, wherein the impact performance comprises a relative penetration force and a relative penetration energy.

Example 5. The process of any one of Examples 1-4, further comprising allowing the part to partially solidify prior to reconfiguring the mold.

Example 6. The process of any one of Examples 1-5, wherein the mold is implemented with a core-back process.

Example 7. The process of any one of Examples 1-6, wherein the mold is implemented with a core-back process that includes a tool configured for precise opening of the mold to increase initial thickness.

Example 8. The process of any one of Examples 1-7, wherein reconfiguring the mold to increase the size of the mold cavity comprises opening the mold.

Example 9. The process of any one of Examples 1-8, wherein reconfiguring the mold to increase the size of the mold cavity results in a foam generation in the part.

Example 10. The process of any one of Examples 1-9, wherein reconfiguring the mold to increase the size of the mold cavity results in a foam generation in a core of the part.

Example 11. A polymeric part made by the process of any one of Examples 1-10 wherein a post-molding length of glass fibers in the part is greater than a post-molding length of glass fibers in a part made without pressurizing the plasticizing unit in more than 50% to 100% of the volume of the plasticizing unit.

Example 12. An injection molding device configured to produce a part, comprising: a hopper configured to introduce a glass fiber filled polymeric material, wherein the glass fibers have a pre-molding length; a plasticizing unit configured to melt the glass fiber filled polymeric material to form a melt; a gas source configured to pressurize the plasticizing unit of the injection molding device with a blowing agent, wherein the gas source is configured to pressurize in more than 50% of the volume of the plasticizing unit; a mold comprising a mold cavity that is configured to change size during molding; the plasticizing unit further configured to deliver the melt into the mold cavity up to 100% of volume to form the part; and the mold configured to increase the size of the mold cavity a predetermined time after a delivery of the melt to produce a part having a relative density less than one, the part having an impact performance greater than a part with a same weight made without pressurizing the plasticizing unit in more than 50% of its volume, and the part having an impact performance greater than a solid part with a same weight.

Example 13. The device of Example 12, wherein the impact performance comprises a relative penetration force.

Example 14. The device of any one of Examples 12-13, wherein the impact performance comprises a relative penetration energy.

Example 15. The device of any one of Examples 12-14, wherein the impact performance comprises a relative penetration force and a relative penetration energy.

Example 16. The device of any one of Examples 12-15, wherein the mold is further configured to allow the part to partially solidify prior to changing the size of the mold cavity.

Example 17. The device of any one of Examples 12-16, wherein the mold is implemented with a core-back process.

Example 18. The device of any one of Examples 12-17, wherein the mold is configured to be implemented with a core-back process that includes a tool configured for precise opening of the mold to increase initial thickness. Example 19. The device of any one of Examples 12-18, wherein the mold is configured to increase the size of the mold cavity to promote foam generation in the part.

Example 20. The device of any one of Examples 12-19, wherein reconfiguring the mold to increase the size of the mold cavity results in a foam generation in a core of the part.

Example 21. The device of any one of Examples 12-20, wherein a packing pressure is applied to the mold cavity after injecting the melt into the mold cavity to limit a dissolved gas from expanding and limiting a formation of foam in the part prior to increasing the size of the mold.

Example 22. The device of any one of Examples 12-21, wherein no packing pressure is applied to the mold cavity after injecting the melt into the mold cavity.

Example 23. The device of any one of Examples 12-22, further comprising a controller configured to control at least one of the following: at least one heater of the plasticizing unit, the gas source of the plasticizing unit, the plasticizing unit, the size of the mold, and a plurality of valves of the hopper.

Example 24. A process of making a part that comprises melting a glass fiber filled polymeric material to form a melt in a plasticizing unit of an injection molding machine; pressurizing the melt in the plasticizing unit using a blowing agent, wherein the pressurizing is performed in more than 50% of a volume of the plasticizing unit; causing the blowing agent to at least partially dissolve into the pressurized melt; injecting the pressurized melt into a mold cavity of a mold; and increasing a volume of the mold cavity after the injecting of the pressurized melt into the mold cavity to produce a part, wherein the part has a relative density less than one and a greater impact performance when compared to a similar part formed from the melt having a same weight and that is not pressurized using a blowing agent, as determined from a falling dart experiment.

Example 25. The process of Example 24, wherein the impact performance comprises a relative penetration force as determined from a falling dart experiment.

Example 26. The process of Example 24, wherein the impact performance comprises a relative penetration energy as determined from a falling dart experiment.

Example 27. The process of Example 24, wherein the impact performance comprises a relative penetration force and a relative penetration energy as determined from a falling dart experiment.

Example 28. The process of any one of Examples 24-27, further comprising allowing the part to partially solidify prior to increasing the volume of the mold cavity.

Example 29. The process of any one of Examples 24-28, wherein the mold implements a core-back process that comprises a controlled opening of the mold from an initial thickness to an end thickness.

Example 30. The process of any one of Examples 24-29, wherein increasing a volume of the mold cavity comprises opening the mold.

Example 31. The process of any one of Examples 24-30, wherein increasing a volume of the mold cavity results in a foam generation in the part.

Example 32. The process of any one of Examples 24-31, wherein increasing a volume of the mold cavity results in a foam generation in a core of the part.

Example 33. A polymeric part made by the process of any one of Examples 24-32, wherein a post-molding length of glass fibers in the part is greater than a post-molding length of glass fibers in a part made without pressurizing a melt in more than 50% of the volume of a plasticizing unit.

Example 34. An injection molding device configured to produce a part, comprising a hopper configured to introduce a glass fiber filled polymeric material, wherein the glass fibers have a pre-molding length; a plasticizing unit configured to melt the glass fiber filled polymeric material to form a melt; a gas source configured to pressurize the plasticizing unit of the injection molding device with a blowing agent, wherein the gas source is configured to pressurize in more than 50% of the volume of the plasticizing unit; a mold comprising a mold cavity that is configured to change size during molding; the plasticizing unit further configured to deliver the melt into the mold cavity up to 100% of volume to form the part; and the mold configured to increase the size of the mold cavity after a predetermined time after a delivery of the melt to produce a part having a relative density less than one, the part having a greater impact performance when compared to a similar part formed from the melt having a same weight and that is not pressurized using a blowing agent, as determined from a falling dart experiment.

Example 35. The device of Example 34, wherein the impact performance comprises a relative penetration force as determined from a falling dart experiment.

Example 36. The device of Example 34, wherein the impact performance comprises a relative penetration energy as determined from a falling dart experiment.

Example 37. The device of Example 34, wherein the impact performance comprises a relative penetration force and a relative penetration energy as determined from a falling dart experiment.

Example 38. The device of any one of Examples 34-37, wherein the mold is further configured to allow the part to partially solidify prior to changing the size of the mold.

Example 39. The device of any one of Examples 34-38, wherein the mold is configured to implement a core-back process that comprises a controlled opening of the mold from an initial thickness to an end thickness.

Example 40. The device of any one of Examples 34-39, wherein the mold is configured to increase the size of the mold cavity to promote foam generation in the part.

Example 41. The device of any one of Examples 34-40, wherein reconfiguring the mold to increase the size of the mold cavity results in a foam generation in a core of the part.

Example 42. The device of any one of Examples 34-41, wherein a packing pressure is applied to the mold cavity after injecting the melt into the mold cavity to limit a dissolved gas from expanding and limiting a formation of foam in the part prior to increasing the size of the mold.

Example 43. The device of any one of Examples 34-42, further comprising a controller configured to control at least one of the following: at least one heater of the plasticizing unit, the gas source of the plasticizing unit, the plasticizing unit, the size of the mold, and a plurality of valves of the hopper.

Further in accordance with various aspects of the disclosure, the methods described herein are intended for operation with a controller including, but not limited to, PCs, PDAs, semiconductors, application specific integrated circuits (ASIC), programmable logic arrays, cloud computing devices, and other hardware devices constructed to implement the methods described herein.

While the disclosure has been described in terms of exemplary aspects, those skilled in the art will recognize that the disclosure can be practiced with modifications in the spirit and scope of the appended claims. These examples given above are merely illustrative and are not meant to be an exhaustive list of all possible designs, aspects, applications or modifications of the disclosure.

What is claimed is:

1. A process of making a part that comprises:
melting a glass fiber filled polymeric material to form a melt in a plasticizing unit of an injection molding machine;
pressurizing the melt in the plasticizing unit using a blowing agent, wherein the pressurizing is performed in more than 50% of a volume of the plasticizing unit;
causing the blowing agent to at least partially dissolve into the pressurized melt;
injecting the pressurized melt into a mold cavity of a mold; and
increasing a volume of the mold cavity after the injecting of the pressurized melt into the mold cavity to produce a part, wherein the part has a relative density less than one and a greater impact performance when compared to a similar part formed from the melt having a same weight and that is not pressurized using a blowing agent, as determined from a falling dart experiment.

2. The process of claim 1, wherein the impact performance comprises a relative penetration force as determined from a falling dart experiment.

3. The process of claim 1, wherein the impact performance comprises a relative penetration energy as determined from a falling dart experiment.

4. The process of claim 1, wherein the impact performance comprises a relative penetration force and a relative penetration energy as determined from a falling dart experiment.

5. The process of any one of claims 1 to 4, further comprising allowing the part to partially solidify prior to increasing the volume of the mold cavity.

6. The process of any one of claims 1 to 5, wherein the mold implements a core -back process that comprises a controlled opening of the mold from an initial thickness to an end thickness.

7. The process of any one of claims 1 to 6, wherein increasing a volume of the mold cavity comprises opening the mold.

8. The process of any one of claims 1 to 7, wherein increasing a volume of the mold cavity results in a foam generation in the part.

9. The process of any one of claims 1 to 8, wherein increasing a volume of the mold cavity results in a foam generation in a core of the part.

10. A polymeric part made by the process of any one of claims 1 to 9, wherein a post-molding length of glass fibers in the part is greater than a post-molding length of glass fibers in a part made without pressurizing a melt in more than 50% of the volume of a plasticizing unit.

11. An injection molding device configured to produce a part, comprising:
a hopper configured to introduce a glass fiber filled polymeric material, wherein the glass fibers have a pre-molding length;
a plasticizing unit configured to melt the glass fiber filled polymeric material to form a melt;
a gas source configured to pressurize the plasticizing unit of the injection molding device with a blowing agent, wherein the gas source is configured to pressurize in more than 50% of the volume of the plasticizing unit;
a mold comprising a mold cavity that is configured to change size during molding;
the plasticizing unit further configured to deliver the melt into the mold cavity up to 100% of volume to form the part; and
the mold configured to increase the size of the mold cavity after a predetermined time after a delivery of the melt to produce a part having a relative density less than one, the part having a greater impact performance when compared to a similar part formed from the melt having a same weight and that is not pressurized using a blowing agent, as determined from a falling dart experiment.

12. The device of claim 11, wherein the impact performance comprises a relative penetration force as determined from a falling dart experiment.

13. The device of claim 11, wherein the impact performance comprises a relative penetration energy as determined from a falling dart experiment.

14. The device of claim 11, wherein the impact performance comprises a relative penetration force and a relative penetration energy as determined from a falling dart experiment.

15. The device of any one of claims 11 to 14, wherein the mold is further configured to allow the part to partially solidify prior to changing the size of the mold.

16. The device of any one of claims 11 to 15, wherein the mold is configured to implement a core-back process that comprises a controlled opening of the mold from an initial thickness to an end thickness.

17. The device of any one of claims 11 to 16, wherein the mold is configured to increase the size of the mold cavity to promote foam generation in the part.

18. The device of any one of claims 11 to 17, wherein reconfiguring the mold to increase the size of the mold cavity results in a foam generation in a core of the part.

19. The device of any one of claims 11 to 18, wherein a packing pressure is applied to the mold cavity after injecting the melt into the mold cavity to limit a dissolved gas from expanding and limiting a formation of foam in the part prior to increasing the size of the mold.

20. The device of any one of claims 11 to 19, further comprising a controller configured to control at least one of the following: at least one heater of the plasticizing unit, the gas source of the plasticizing unit, the plasticizing unit, the size of the mold, and a plurality of valves of the hopper.
